(19) United States
(12) Patent Application Publication
(10) Pub. No.: US 2023/0265247 A1
(43) Pub. Date: Aug. 24, 2023

(54) PROCESS FOR PREPARING POLYIMIDES

(71) Applicant: Technische Universität Wien, Wien (AT)

(72) Inventors: Miriam Margarethe UNTERLASS, Wien (AT); Daniel Alonso CERRON-INFANTES, Wien (AT)

(73) Assignee: Technische Universität Wien, Wien (AT)

(21) Appl. No.: 18/012,465

(22) PCT Filed: Jun. 17, 2021
(86) PCT No.: PCT/AT2021/060206

§ 371 Date: Dec. 22, 2022

(30) Foreign Application Priority Data
Jun. 23, 2020 (AT) A 50531/2020

(51) Int. Cl. C08G 73/10

(52) U.S. Cl. CPC C08G 73/1032

(57) ABSTRACT

The invention relates to a stoichiometric salt of a tetracarboxylic acid and a diamine of the following general formula (I),

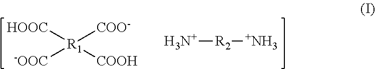

wherein R₁ is selected from tetravalent residues of butane, cyclobutane, cyclopentane, cyclohexane, tetrahydrofurane and benzophenone and R₂ is selected from divalent residues of unbranched, branched or cyclic aliphatic hydrocarbons with 3 to 15 carbon atoms, with the proviso that the salt of the formula (I) is water-soluble and is selected from compounds (1) to (28); and to the polyimides prepared from these salts by polycondensation.

The present invention relates to a novel process for preparing polyimides.

### PRIOR ART

Polyimides are valuable materials for a wide range of applications. They are usually synthesized by polycondensation of diamines with tetracarboxylic acids or dianhydrides thereof in solution or in the molten or even in the solid state. One common approach is to form a stoichiometric salt of diamine and tetracarboxylic acid or dianhydride thereof before the polymerization, which is usually done by simply mixing the monomers in water and isolating the water-insoluble and hence precipitated salts, as is also described, for example, in WO 2016/032299 A1. Thereby, the anhydrides undergo hydrolysis to form the free tetracarboxylic acids, of which two carboxyl groups each form an ammonium salt with an amino group (Unterlass et al., “Mechanistic study of hydrothermal synthesis of aromatic polyimides,” Polym. Chem. 2011, 2, 1744). In the monomer salts obtained in this manner, which are sometimes referred to as “AH salts” (in analogy to polyamide and especially nylon synthesis), the two monomers are present in a molar ratio of exactly 1:1, which is why the subsequent polymerization thereof results in very pure polyimides. Below is one example of the reaction scheme of two typical aromatic monomers:

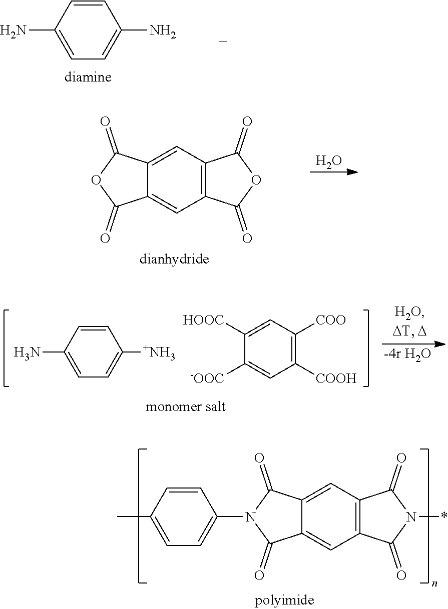

In recent years, it has been discovered that some of the diamine and tetracarboxylic acid monomer salts are water-soluble, which offers a great advantage in the manufacture of polyimides as it eliminates the need to use organic solvents. For example, an aqueous solution of the salts can be used to coat surfaces, after which the coating can be dried by heating and imidized at the same time, with only water vapor as a by-product. Nevertheless, corresponding disclosures for the preparation of water-soluble monomer salts can only be found in a few documents of the patent literature, namely in JP 2000/319389 A, JP 2002/121348 A, and JP 2013/256642 A, as well as in the patent family of the present inventors based on AT 519.038.

In all three of the Japanese patent applications cited above, only one single monomer salt was actually produced and subjected to polyimidation, namely that resulting from benzophenone tetracarboxylic acid and m-xylylenediamine:

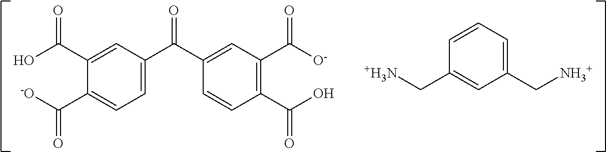

JP 2002/121348 A and, in particular, the earlier application JP 2000/319389 A from the same applicant lists further examples of diamines and tetracarboxylic acids which, in combination, are said to yield water-soluble monomer salts. In the latter document, these include predominantly (namely 35) aromatic diamines, but also some (10) alicyclic diamines based on cyclohexyl residues, some (14) aliphatic diamines, and two polyether diamines. The tetracarboxylic acids cited as being combinable therewith are again primarily (8) aromatic, a few (3) alicyclic (cyclopropane, cyclopentane and hexane tetracarboxylic acid) and butane tetracarboxylic acid as the only aliphatic representative. But whether the monomer salts to be prepared from combinations thereof are actually water-soluble is neither examined nor demonstrated in either document.

In their earlier work, the results of which are disclosed in the patent family of the Austrian parent application AT 519.038 A1, the present inventors developed several monomer salts from combinations of m-xylylenediamine and ethylenediamine with three tetracarboxylic acids, namely benzophenone-, butane- and tetrahydrofurantetracarboxylic acid (thus also including the above salt from benzophenone tetracarboxylic acid and m-xylylenediamine) and confirmed their water solubility in each case. However, the inventors had also prepared a series of monomer salts that proved not to be water-soluble.

Against this background, it was the object of the present invention to provide further monomer salts that have been shown to be water-soluble and to process aqueous solutions thereof in order to form polyimides.

### DISCLOSURE OF THE INVENTION

The present invention achieves this object in a first aspect by providing a stoichiometric salt of a tetracarboxylic acid and a diamine of the following general formula (I):

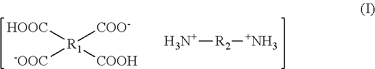

wherein R₁ is selected from tetravalent residues of butane, cyclobutane, cyclopentane, cyclohexane, tetrahydrofuran and benzophenone and R₂ is selected from divalent residues of straight, branched or cyclic aliphatic hydrocarbons having from 3 to 15 carbon atoms, the stoichiometric salt of formula (I) being characterized in that
i) it is water-soluble; and
ii) it is selected from the following compounds:

### a) Salts of tetrahydrofuran-2,3,4,5-tetracarboxylic acid with aliphatic diamines

Propane-1,3-diammonium-dihydrogen-tetrahydrofuran-2,3,4,5-tetracarboxylate (1),
Butane-1,4-diammonium-dihydrogen-tetrahydrofuran-2,3,4,5-tetracarboxylate (2),
Pentane-1,5-diammonium-dihydrogen-tetrahydrofuran-2,3,4,5-tetracarboxylate (3),
2,2-Dimethylpropane-1,3-diammonium-dihydrogen-tetrahydrofuran-2,3,4,5-tetracarboxylate (4),
Hexane-1,6-diammonium-dihydrogen-tetrahydrofuran-2,3,4,5-tetracarboxylate (5),
2-Methylpentane-1,5-diammonium-dihydrogen-tetrahydrofuran-2,3,4,5-tetracarboxylate (6),
Heptane-1,7-diammonium-dihydrogen-tetrahydrofuran-2,3,4,5-tetracarboxylate (7),
Octane-1,8-diammonium-dihydrogen-tetrahydrofuran-2,3,4,5-tetracarboxylate (8),
Nonane-1,9-diammonium-dihydrogen-tetrahydrofuran-2,3,4,5-tetracarboxylate (9);

### b) Salts of tetrahydrofuran-2,3,4,5-tetracarboxylic acid with alicyclic diamines

Cyclohexane-1,2-diammonium-dihydrogen-tetrahydrofuran-2,3,4,5-tetracarboxylate (10),
Cyclohexane-1,3-diammonium-dihydrogen-tetrahydrofuran-2,3,4,5-tetracarboxylate (11)
Cyclohexane-1,4-diammonium-dihydrogen-tetrahydrofuran-2,3,4,5-tetracarboxylate (12),
Cyclohexane-1,3-bis(methanammonium)-dihydrogen-tetrahydrofuran-2,3,4,5-tetracarboxylate (13),
Cyclohexane-1,4-bis(methanammonium)-dihydrogen-tetrahydrofuran-2,3,4,5-tetracarboxylate (14),
Norbornane bis(methylammonium)-dihydrogen-tetrahydrofuran-2,3,4,5-tetracarboxylate (15),
Isophorone diammonium-dihydrogen-tetrahydrofuran-2,3,4,5-tetracarboxylate (16),
Tricyclo[5.2.1.0^{2,6}]decane-3(4),8(9)-bis(methanammonium)-dihydrogen-tetrahydrofuran-2,3,4,5-tetracarboxylate (17),
4,4′-Methylene-bis(2-methylcyclohexylammonium)-dihydrogen-tetrahydrofuran-2,3,4,5-tetracarboxylate (18);

### c) Salts of 1,2,3,4-butanetetracarboxylic acid with alicyclic diamines

Norbornane bis(methylammonium)-dihydrogen-1,2,3,4-butanetetracarboxylate (19),
Tricyclo[5.2.1.0^{2,6}]decane-3(4),8(9)-bis(methanammonium)-dihydrogen-1,2,3,4-butanetetracarboxylate (20);

### d) Salts of 1,2,3,4-cyclobutanetetracarboxylic acid with alicyclic diamines

Norbornane bis(methylammonium)-dihydrogen-1,2,3,4-cyclobutanetetracarboxylate (21),
Tricyclo[5.2.1.0^{2,6}]decane-3(4),8(9)-bis(methanammonium)-dihydrogen-1,2,3,4-cyclobutanetetracarboxylate (22);

### e) Salts of 1,2,3,4-cyclopentanetetracarboxylic acid with alicyclic diamines

Norbornane bis(methylammonium)-dihydrogen-1,2,3,4-cyclopentanetetracarboxylate (23),
Tricyclo[5.2.1.0^{2,6}]decane-3(4),8(9)-bis(methanammonium)-dihydrogen-1,2,3,4-cyclopentanetetracarboxylate (24);

### f) Salts of 1,2,4,5-cyclohexanetetracarboxylic acid with alicyclic diamines

Norbornane bis(methylammonium)-dihydrogen-1,2,4,5-cyclohexanetetracarboxylate (25),
Tricyclo[5.2.1.0^{2,6}]decane-3(4),8(9)-bis(methanammonium)-dihydrogen-1,2,4,5-cyclohexanetetracarboxylate (26); and

### g) Salts of 3,3′,4,4′-benzophenonetetracarboxylic acid with alicyclic diamines

Norbornane bis(methylammonium)-dihydrogen-3,3′,4,4′-benzophenone-tetracarboxylate (27),
Tricyclo[5.2.1.0^{2,6}]decane-3(4),8(9)-bis(methanammonium)-dihydrogen-3,3′,4,4′-benzophenonetetracarboxylate (28).

All of these stoichiometric salts (1) to (28) of formula (I) have hitherto never been described in the literature and have not been suggested as possible combinations of a tetra-carboxylic acid and a diamine, and they are all readily soluble in water.

The average person skilled in the art may be of the opinion that, against the background of the prior art cited at the outset, in which numerous tetracarboxylic acid/diamine salt combinations are disclosed as water-soluble, it would have been obvious to prepare salts from other combinations and to examine them for their water solubility. In the course of their research, however, the inventors of the subject matter of the present application also prepared numerous combinations from among those disclosed as water-soluble in JP 2000/319389 A and found that the majority of the combinations of the diamines and tetracarboxylic acids listed there should not be water-soluble. More precisely, all of the salts that were tested using at least one aromatic reactant were not water-soluble—not even the salt from benzophenonetetracarboxylic acid and p-xylylenediamine, even though the one with m-xylylenediamine, which is the only one that is actually prepared and tested in JP 2000/319389 A, is indeed water-soluble and forms the basis for the Japanese patent applications cited above, which was extremely surprising. In addition, however, some salts of non-aromatic diamines or tetracarboxylic acids listed in JP 2000/319389 A were also insoluble in water, as is specifically demonstrated in the comparative examples that will follow. As a result, it can be assumed that, of the more than 700 possible combinations resulting from the acids and amines listed in JP 2000/319389 A, more than 600 are actually not water-soluble. The fact that the vast majority of these would turn out to be water-soluble when other combinations were investigated was therefore extremely surprising for the inventors of the subject matter of the present application and was in no way predictable.

In preferred embodiments of the invention, the salt of formula (I) is selected for the reasons set out below from either the above compounds (2), (3), and (5) to (9) or from the above compounds (10) to (28), in which the residue R₂ of the alicyclic diammonium ion is present in each case as a mixture of multiple isomers.

These selections are based, on the one hand, on the surprising discovery that, among the salts from tetrahydrofuran-2,3,4,5-tetracarboxylic acid with aliphatic diamines, good film-forming properties were found in the preparation of surface coatings with an aqueous solution of the salts only starting from a diamine chain length of 4 carbon atoms—i.e., 1,4-diaminobutane in compound (2). In contrast, with aqueous solutions of the salt from tetrahydrofuran-2,3,4,5-tetracarboxylic acid with 1,3-diaminopropane, i.e., compound (1), and that with 2,2-dimethyl diaminopropane, i.e., compound (4), as well as the salt previously prepared by the inventors with ethylenediamine (see AT 519.038 A1), each exhibited strong foaming, which led to the formation of bubbles when they were used for surface coatings.

Furthermore, it was surprisingly found that, if the aliphatic diamine has a chain length of greater than 10 carbon atoms, it was no longer possible to obtain water-soluble salts—regardless of which tetracarboxylic acid was used.

And, on the other hand, of the compounds (10) to (28), all of which are salts of alicyclic diamines with various acids, including benzophenonetetracarboxylic acid, those salts in which the alicyclics exist as mixtures of multiple stereoisomers are preferable, as mentioned above. This is based on another surprising discovery by the inventors, namely that when isomer mixtures are present, the salts have better solubility than when using alicyclic diamines, of which only one stereoisomer exists. This was evident above all because, among the two diamines 4,4′-methylene-bis(cyclohexylamine) and the dimethyl derivative thereof, 4,4′-methylene-bis(2-methylcyclohexylamine), in combination with three different tetracarboxylic acids (aromatic, alicyclic, aliphatic), only the methylated derivative yielded a water-soluble salt, but not the unmethylated diamine, in all three cases. However, since this is diametrically opposed to the water solubility of the two diamines, the presence of stereoisomers apparently improves the water solubility of the stoichiometric salts.

All of this is explained and documented in more detail in the examples and comparative examples that will follow.

In a second aspect, the present invention also provides a process for preparing a salt of formula (I) according to the first aspect by mixing the respective tetracarboxylic acid or dianhydride thereof with the respective diamine in a solvent and then isolating the stoichiometric salt thereby formed , the process being characterized in that
the tetracarboxylic acid or dianhydride thereof is dissolved, optionally under heating, in an organic solvent that is a solvent for both reactants but a non-solvent for the salt, followed by addition of the diamine and stirring of the reaction mixture to form the stoichiometric salt, which subsequently precipitates out of the solution and is isolated, wherein, optionally, namely in preferred embodiments,
an aliphatic diamine having a chain length of 4 to 9 carbon atoms is added; or
an alicyclic diamine in the form of a mixture of multiple isomers is added.

In contrast to the process disclosed in AT 519.038 A1, according to the present invention the tetracarboxylic acid and the diamine are not combined directly in water as a solvent for salt formation, but in an organic solvent that is capable of dissolving both reactants but not the salt thereof. This has the advantage that the salt formed in this manner precipitates out of the solution, while at least the majority of possible impurities remain in solution.

Polar solvents, especially protic polar solvents, are preferred as the solvent for this purpose, and isopropanol is particularly used since it is easy to evaporate from the precipitated salt.

In a third aspect, the present invention also provides the use of the salts of formula (I) according to the first aspect for the preparation of polyimides, for which purpose polyimides are prepared in preferred embodiments by subjecting an aqueous solution of the salt of formula (I) to a processing step and subsequent heating it in order to bring about polycondensation and simultaneously evaporate the water. This offers the advantage that no organic solvent escapes into the environment during processing and subsequent polycondensation.

In the processing step, the aqueous solution of the salt is preferably either formed into a desired shape or applied to a surface prior to heating. In preferred embodiments, the aqueous solution is formed into the desired shape by foaming, it being possible to add a foaming agent and/or a foam stabilizer prior to foaming as needed, for which purpose one or more fatty acid dialkanolamides can be added, for example.

And in a final aspect, the present invention also relates to polyimide of the general formula (II) that is prepared using a salt of formula (I):

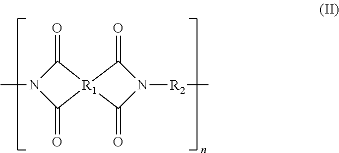

wherein R₁ and R₂ are as previously defined and n is ≥2, the resulting polyimide being characterized in that it is selected from the following:

### a) polyimides from tetrahydrofuran-2,3,4,5-tetracarboxylic acid and aliphatic diamines

poly(N,N′-(1,3-propylene)tetrahydrofuran-2,3,4,5-tetracarboxylic acid diimide) (101),
poly(N,N′-(1,4-butylene)tetrahydrofuran-2,3,4,5-tetracarboxylic acid diimide) (102),
poly(N,N′-(1,5-pentylene)tetrahydrofuran-2,3,4,5-tetracarboxylic acid diimide) (103),
poly(N,N′-(2,2-dimethyl-1,3-propylene)tetrahydrofuran-2,3,4,5-tetracarboxylic acid diimide) (104),
poly(N,N′-(1,6-hexylene)tetrahydrofuran-2,3,4,5-tetracarboxylic acid diimide) (105),
poly(N,N′-(2-methyl-1,5-pentylene)tetrahydrofuran-2,3,4,5-tetracarboxylic acid diimide) (106),
poly(N,N′-(1,7-heptylene)tetrahydrofuran-2,3,4,5-tetracarboxylic acid diimide) (107),
poly(N,N′-(1,8-octylene)tetrahydrofuran-2,3,4,5-tetracarboxylic acid diimide) (108),
poly(N,N′-(1,9-nonylene)tetrahydrofuran-2,3,4,5-tetracarboxylic acid diimide) (109);

### b) polyimides from tetrahydrofuran-2,3,4,5-tetracarboxylic acid and alicyclic diamines

poly(N,N′-(1,2-cyclohexylene)tetrahydrofuran-2,3,4,5-tetracarboxylic acid diimide) (110),
poly(N,N′-(1,3-cyclohexylene)tetrahydrofuran-2,3,4,5-tetracarboxylic acid diimide) (111),
poly(N,N′-(1,4-cyclohexylene)tetrahydrofuran-2,3,4,5-tetracarboxylic acid diimide) (112),
poly(N,N′-(cyclohexane-1,3-dimethylene)tetrahydrofuran-2,3,4,5-tetracarboxylic acid diimide) (113),
poly(N,N′-(cyclohexane-1,4-dimethylene)tetrahydrofuran-2,3,4,5-tetracarboxylic acid diimide) (114),
poly(N,N′-(norbornane dimethylene)tetrahydrofuran-2,3,4,5-tetracarboxylic acid diimide) (115),
poly(N,N′-(isophorylene)tetrahydrofuran-2,3,4,5-tetracarboxylic acid diimide) (116),
poly(N,N′-(tricyclo[5.2.1.0^{2,6}]decane-3(4),8(9)-dimethylene)tetrahydrofuran-2,3,4,5-tetracarboxylic acid diimide) (117),
poly(N,N′-(4,4′-methylene-bis(2-methylcyclohexyl)tetrahydrofuran-2,3,4,5-tetracarboxylic acid diimide) (118);

### c) polyimides from 1,2,3,4-butanetetracarboxylic acid and alicyclic diamines

poly(N,N′-(norbornane dimethylene)butane-1,2,3,4-tetracarboxylic acid diimide) (119),
poly(N,N′-(tricyclo[5.2.1.0^{2,6}]decane-3(4),8(9)-dimethylene)butane-1,2,3,4-tetracarboxylic acid diimide) (120);

### d) polyimides from 1,2,3,4-cyclobutanetetracarboxylic acid and alicyclic diamines

poly(N,N′-(norbornane dimethylene)cyclobutane-1,2,3,4-tetracarboxylic acid diimide) (121),
poly(N,N′-(tricyclo[5.2.1.0^{2,6}]decane-3(4),8(9)-dimethylene)cyclobutane-1,2,3,4-tetracarboxylic acid diimide) (122);

### e) polyimides from 1,2,3,4-cyclopentanetetracarboxylic acid and alicyclic diamines

poly(N,N′-(norbornane dimethylene)cyclopentane-1,2,3,4-tetracarboxylic acid diimide) (123),
poly(N,N′-(tricyclo[5.2.1.0^{2,6}]decane-3(4),8(9)-dimethylene)cyclopentane-1, 2,3,4-tetracarboxylic acid diimide) (124);

### f) polyimides from 1,2,4,5-cyclohexanetetracarboxylic acid and alicyclic diamines

poly(N,N′-(norbornane dimethylene)cyclohexane-1,2,4,5-tetracarboxylic acid diimide) (125),
poly(N,N′-(tricyclo[5.2.1.0^{2,6}]decane-3(4),8(9)-dimethylene)cyclohexane-1,2,4,5-tetracarboxylic acid diimide) (126); and

### g) polyimides from 3,3′,4,4′-benzophenonetetracarboxylic acid and alicyclic diamines

poly(N,N′-(norbornane dimethylene)-3,3′,4,4′-benzophenonetetracarboxylic acid diimide) (127),
poly(N,N′-(tricyclo[5.2.1.0^{2,6}]decane-3(4),8(9)-dimethylene)-3,3′,4,4′-benzophenone-tetracarboxylic acid diimide) (128).

Like the stoichiometric monomer salts of formula (I) used for their preparation, these polyimides are all novel, can be prepared from aqueous solutions of the salts in a simple, inexpensive, and environmentally friendly manner, and have advantageous properties, such as high flexibility on the part of coatings made of them.

### EXAMPLES

The present invention will be described in greater detail below on the basis of concrete exemplary embodiments and comparative examples.

All reagents were purchased from commercial sources and used without further purification. IR spectra were obtained by means of FT-IR ATRR spectroscopy on a Tensor 27, and ¹H and ¹³C-NMR spectra were recorded on an Avance 250 or DRX-400 FT spectrometer operating at 250 or 400 MHz, all from Bruker. TGA measurements were made using a Perkin Elmer TGA 8000 Thermogravimetric Analyzer, and a Hettich ROTANTA 460R centrifuge was used to centrifuge the monomer salt suspensions.

### Synthesis 1

### General Protocol for Preparing the Monomer Salts of Formula (I)

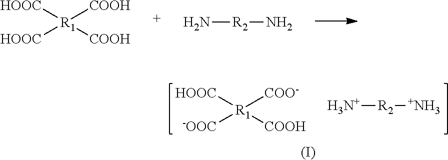

In a 50 ml round bottom flask fitted with a reflux condenser, around 0.7 mmol of the respective tetracarboxylic acid R₁(COOH)₄ was mixed with 50 ml of isopropanol and stirred magnetically, optionally under heating to no more than 80° C., until a clear solution formed, which was allowed to cool. An equimolar amount of the respective diamine H₂N—R₂—NH₂ was then added all at once at room temperature in solid form or, in the case of liquid diamines, using a micropipette, and the mixture was stirred under standard conditions for several hours. The resulting suspension of the precipitated stoichiometric salt was centrifuged for several minutes at 11,500 rpm, decanted, washed again with isopropanol, and again centrifuged at 11,500 rpm for several minutes, after which the liquid phase was decanted and the solid salt was dried under high vacuum to constant weight. The yields achieved were consistently quantitative.

### Synthesis 2

General Protocol for Preparing the Polyimides of Formula (II)

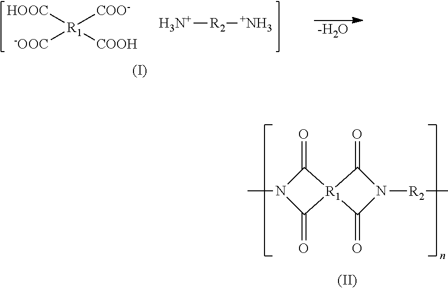

Consistently clear solutions of about 40% by weight were prepared of the respective monomer salt of formula (I) in 1 ml distilled water in a glass beaker. These solutions were applied using a Pasteur pipette to glass or aluminum surfaces, which were placed in a programmable oven at 50° C. and then subjected to a temperature program from 50° C. to 250° C. over 38-62 h in order to evaporate the water and to ensure complete polycondensation to the polyimide of formula (II). After the specimens had cooled, the resulting polyimide films were peeled off the surfaces and analyzed by FT-IRR-ATR and TGA.

### Comparative Examples 1 to 107 and Examples 1 to 28

### Preparation and Examination of Stoichiometric Salts of Formula (I)

Stoichiometric salts of formula (I) were prepared as described above under “Synthesis 1” and then tested for solubility by mixing 1 ml of distilled water with around 20 to 40% by weight of the respective salt and stirring for 15 minutes. Those salts with which no clear solution without appreciable amounts of precipitate as a sediment were obtained were referred to as being “insoluble in water.”

The following tetracarboxylic acids were used for this purpose:

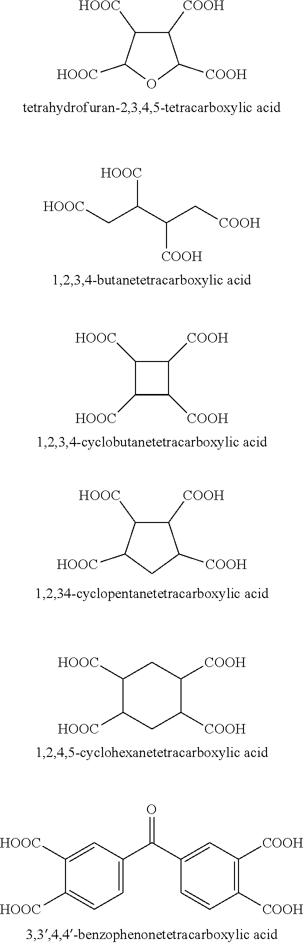 [SMILES: O=C(O)C1OC(C(=O)O)C(C(=O)O)C1C(=O)O ; O=C(O)CC(C(=O)O)C(CC(=O)O)C(=O)O ; O=C(O)C1C(C(=O)O)C(C(=O)O)C1C(=O)O ; O=C(O)C1CC(C(=O)O)C(C(=O)O)C1C(=O)O ; O=C(O)C1CC(C(=O)O)C(C(=O)O)CC1C(=O)O ; O=C(c1ccc(C(=O)O)c(C(=O)O)c1)c1ccc(C(=O)O)c(C(=O)O)c1]

The diamines used were i) the following aliphatic diamines:

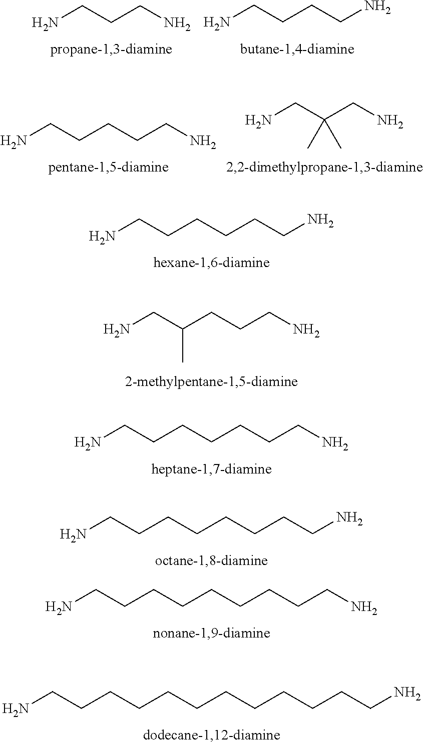

as well as ii) the following alicyclic diamines:

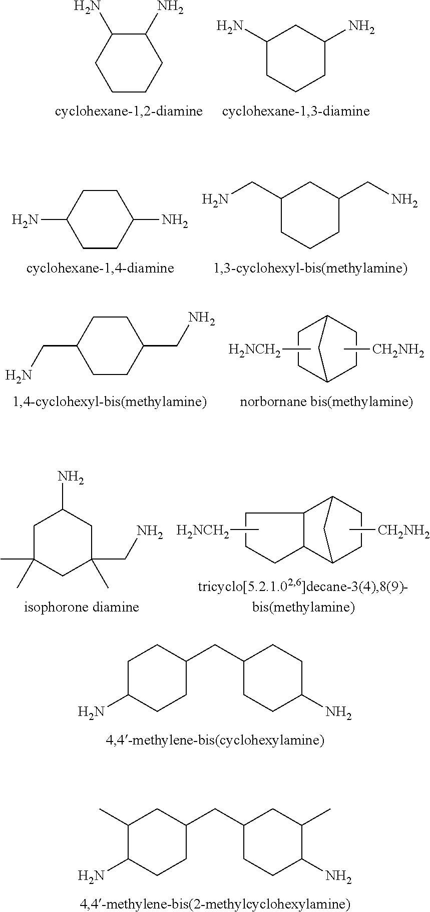

and iii) the following aromatic diamines:

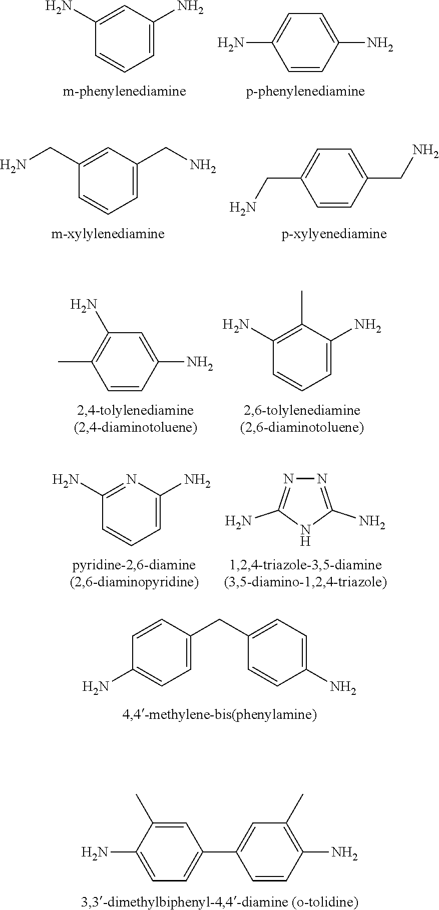

The results of the solubility tests obtained for the examples (B1 to B28) and comparative examples (C1 to C107) are summarized in the tables overleaf.

TABLE 1
Salts of tetrahydrofuran-2,3,4,5-tetracarboxylic acid

| | | | | Salt can be |
|---|---|---|---|---|
| | | Compound | Salt is water- | derived from the |
| Example | Diamine | no. | soluble | prior art |
| | Aliphatic diamines | | | |
| B1 | Propane-1,3-diamine | 1 | yes | no |
| B2 | Butane-1,4-diamine | 2 | yes | no |
| B3 | Pentane-1,5-diamine | 3 | yes | no |
| B4 | 2,2-Dimethylpropane-1,3-diamine | 4 | yes | no |
| B5 | Hexane-1,6-diamine | 5 | yes | no |
| B6 | 2-Methylpentane-1,5-diamine | 6 | yes | no |
| B7 | Heptane-1,7-diamine | 7 | yes | no |
| B8 | Octane-1,8-diamine | 8 | yes | no |
| B9 | Nonane-1,9-diamine | 9 | yes | no |
| V1 | Dodecane-1,12-diamine | — | no | no |
| | Alicyclic diamines | | | no |
| B10 | Cyclohexane-1,2-diamine | 10 | yes | no |
| B11 | Cyclohexane-1,3-diamine | 11 | yes | no |
| B12 | Cyclohexane-1,4-diamine | 12 | yes | no |
| B13 | 1,3-Cyclohexyl-bis(methylamine) | 13 | yes | no |
| B14 | 1,4-Cyclohexyl-bis(methylamine) | 14 | yes | no |
| B15 | Norbornane bis(methylamine) | 15 | yes | no |
| B16 | Isophorone diamine | 16 | yes | no |
| B17 | Tricyclo[5.2.1.0^{2,6}]decane-3(4),8(9)- | 17 | yes | no |
| | bis(methylamine) | | | |
| V2 | 4,4′-Methylene-bis(cyclohexylamine) | — | no | no |
| B18 | 4,4′-Methylene-bis(2-methylcyclohexylamine) | 18 | yes | no |
| | Aromatic diamines | | | |
| V3 | m-Phenylenediamine | — | no | no |
| V4 | p-Phenylenediamine | — | no | no |
| V5 | m-Xylylenediamine | — | yes | yes |
| V6 | p-Xylylenediamine | — | no | no |
| V7 | 2,4-Tolylenediamine | — | no | no |
| V8 | 2,6-Tolylenediamine | — | no | no |
| V9 | Pyridine-2,6-diamine | — | no | no |
| V10 | 1,2,4-Triazole-3,5-diamine | — | no | no |
| V11 | 4,4′-Methylene-bis(phenylamine) | — | no | no |
| V12 | 3,3′-Dimethylbiphenyl-4,4′-diamine | — | no | no |

TABLE 2
Salts of 1,2,3,4-butanetetracarboxylic acid

| | | | | Salt can be |
|---|---|---|---|---|
| | | Compound | Salt is water- | derived from the |
| Example | Diamine | no. | soluble | prior art |
| | Aliphatic diamines | | | |
| V13 | Propane-1,3-diamine | — | yes | yes |
| V14 | Butane-1,4-diamine | — | yes | yes |
| V15 | Pentane-1,5-diamine | — | yes | yes |
| V16 | 2,2-Dimethylpropane-1,3-diamine | — | yes | yes |
| V17 | Hexane-1,6-diamine | — | yes | yes |
| V18 | 2-Methylpentane-1,5-diamine | — | yes | yes |
| V19 | Heptane-1,7-diamine | — | yes | yes |
| V20 | Octane-1,8-diamine | — | yes | yes |
| V21 | Nonane-1,9-diamine | — | yes | yes |
| V22 | Dodecane-1, 12-diamine | | no | yes |
| | Alicyclic diamines | | | yes |
| V23 | Cyclohexane-1,2-diamine | — | yes | yes |
| V24 | Cyclohexane-1,3-diamine | — | yes | yes |
| V25 | Cyclohexane-1,4-diamine | — | yes | yes |
| V26 | 1,3-Cyclohexyl-bis(methylamine) | — | yes | yes |
| V27 | 1,4-Cyclohexyl-bis(methylamine) | — | yes | yes |
| B19 | Norbornane bis(methylamine) | 15 | yes | no |
| V28 | Isophorone diamine | 16 | yes | yes |
| B20 | Tricyclo[5.2.1.02.6]decane-3(4),8(9)- | 17 | yes | no |
| | bis(methylamine) | | | |
| V29 | 4,4′-Methylene-bis(cyclohexylamine) | — | no | yes |
| V30 | 4,4′-Methylene-bis(2-methylcyclohexylamine) | 18 | yes | yes |
| | Aromatic diamines | | | |
| V31 | m-Phenylenediamine | — | no | yes |
| V32 | p-Phenylenediamine | — | no | yes |
| V33 | m-Xylylenediamine | — | yes | yes |
| V34 | p-Xylylenediamine | — | no | yes |
| V35 | 2,4-Tolylenediamine | — | no | yes |
| V36 | 2,6-Tolylenediamine | — | no | yes |
| V37 | Pyridine-2,6-diamine | — | no | no |
| V38 | 1,2,4-Triazole-3,5-diamine | — | no | no |
| V39 | 4,4′-Methylene-bis(phenylamine) | — | no | yes |
| V40 | 3,3′-Dimethylbiphenyl-4,4′-diamine | — | no | yes |

TABLE 3
Salts of 1,2,3,4-cyclobutanetetracarboxylic acid

| | | | | Salt can be |
|---|---|---|---|---|
| | | Compound | Salt is water- | derived from the |
| Example | Diamine | no. | soluble | prior art |
| | Aliphatic diamines | | | |
| V41 | Propane-1,3-diamine | — | yes | yes |
| V42 | Butane-1,4-diamine | — | yes | yes |
| V43 | Pentane-1,5-diamine | — | yes | yes |
| V44 | Hexane-1,6-diamine | — | yes | yes |
| V45 | 2-Methylpentane-1,5-diamine | — | yes | yes |
| V46 | Heptane-1,7-diamine | — | yes | yes |
| V47 | Octane-1,8-diamine | — | yes | yes |
| V48 | Nonane-1,9-diamine | — | yes | yes |
| | Alicyclic diamines | — | yes | yes |
| V49 | Cyclohexane-1,2-diamine | | yes | yes |
| V50 | Cyclohexane-1,3-diamine | | | yes |
| V51 | Cyclohexane-1,4-diamine | — | yes | yes |
| V52 | 1,3-Cyclohexyl-bis(methylamine) | — | yes | yes |
| V53 | 1,4-Cyclohexyl-bis(methylamine) | — | yes | yes |
| B21 | Norbornane bis(methylamine) | 21 | yes | no |
| V54 | Isophorone diamine | — | yes | yes |
| B22 | Tricyclo[5.2.1.0^{2.6}]decane-3(4),8(9)- | 22 | yes | no |
| | bis(methylamine) | | | |
| | Aromatic diamines | | | |
| V55 | m-Xylylenediamine | — | yes | yes |

TABLE 4
Salts of 1,2,3,4-cyclopentanetetracarboxylic acid

| | | | | Salt can be |
|---|---|---|---|---|
| | | Compound | Salt is water- | derived from the |
| Example | Diamine | no. | soluble | prior art |
| | Aliphatic diamines | | | |
| V56 | Propane-1,3-diamine | — | yes | yes |
| V57 | Butane-1,4-diamine | — | yes | yes |
| V58 | Pentane-1,5-diamine | — | yes | yes |
| V59 | Hexane-1,6-diamine | — | yes | yes |
| V60 | 2-Methylpentane-1,5-diamine | — | yes | yes |
| V61 | Heptane-1,7-diamine | — | yes | yes |
| V62 | Octane-1,8-diamine | — | yes | yes |
| V63 | Nonane-1,9-diamine | — | yes | yes |
| | Alicyclic diamines | | | |
| V64 | Cyclohexane-1,2-diamine | — | yes | yes |
| V65 | Cyclohexane-1,3-diamine | — | yes | yes |
| V66 | Cyclohexane-1,4-diamine | — | yes | yes |
| V67 | 1,3-Cyclohexyl-bis(methylamine) | — | yes | yes |
| V58 | 1,4-Cyclohexyl-bis(methylamine) | — | yes | yes |
| B23 | Norbornane bis(methylamine) | 23 | yes | no |
| V69 | Isophorone diamine | — | yes | yes |
| B24 | Tricyclo[5.2.1.0^{2,6}]decane-3(4),8(9)- | 24 | yes | no |
| | bis(methylamine) | | | |
| | Aromatic diamines | | | |
| V70 | m-Xylylenediamine | — | yes | yes |

TABLE 5
Salts of 1,2,4,5-cyclohexanetetracarboxylic acid

| | | | | Salt can be |
|---|---|---|---|---|
| | | Compound | Salt is water- | derived from the |
| Example | Diamine | no. | soluble | prior art |
| | Aliphatic diamines | | | |
| V71 | Propane-1,3-diamine | — | yes | yes |
| V72 | Butane-1,4-diamine | — | yes | yes |
| V73 | Pentane-1,5-diamine | — | yes | yes |
| V74 | Hexane-1,6-diamine | — | yes | yes |
| V75 | 2-Methylpentane-1,5-diamine | — | yes | yes |
| V76 | Heptane-1,7-diamine | — | yes | yes |
| V77 | Octane-1,8-diamine | — | yes | yes |
| V78 | Nonane-1,9-diamine | — | yes | yes |
| | Alicyclic diamines | | | |
| V79 | Cyclohexane-1,2-diamine | — | yes | yes |
| V80 | Cyclohexane-1,3-diamine | — | yes | yes |
| V81 | Cyclohexane-1,4-diamine | — | yes | yes |
| V82 | 1,3-Cyclohexyl-bis(methylamine) | — | yes | yes |
| V83 | 1,4-Cyclohexyl-bis(methylamine) | — | yes | yes |
| B25 | Norbornane bis(methylamine) | 25 | yes | no |
| V84 | Isophorone diamine | — | yes | yes |
| B26 | Tricyclo[5.2.1.0^{2.6}]decane-3(4),8(9)- | 26 | yes | no |
| | bis(methylamine) | | | |
| | Aromatic diamines | | | |
| V85 | m-Xylylenediamine | — | yes | yes |

TABLE 6
Salts of 3,3′,4,4′-benzophenonetetracarboxylic acid

| | | | | Salt can be |
|---|---|---|---|---|
| | | Compound | Salt is water- | derived from the |
| Example | Diamine | no. | soluble | prior art |
| | Aliphatic diamines | | | |
| V86 | Butane-1,4-diamine | — | no | yes |
| V87 | Pentane-1,5-diamine | — | no | yes |
| V88 | 2,2-Dimethylpropane-1,3-diamine | — | yes | yes |
| V8 | Hexane-1,6-diamine | — | no | yes |
| V90 | 2-Methylpentane-1,5-diamine | — | no | yes |
| V91 | Heptane-1,7-diamine | — | no | yes |
| V92 | Octane-1,8-diamine | — | no | yes |
| V93 | Nonane-1,9-diamine | — | no | yes |
| V94 | Dodecane-1,12-diamine | | no | yes |
| | Alicyclic diamines | | | yes |
| B27 | Norbornane bis(methylamine) | 27 | yes | no |
| V95 | Isophorone diamine | — | yes | yes |
| B28 | Tricyclo[5.2.1.0^{2.6}]decane-3(4),8(9)- | 28 | yes | no |
| | bis(methylamine) | | | |
| V96 | 4,4′-Methylene-bis(cyclohexylamine) | — | no | yes |
| V97 | 4,4′-Methylene-bis(2-methylcyclohexylamine) | — | yes | yes |
| | Aromatic diamines | | | |
| V98 | m-Phenylenediamine | — | no | yes |
| V99 | p-Phenylenediamine | — | no | yes |
| V100 | m-Xylylenediamine | — | yes | yes |
| V101 | p-Xylylenediamine | — | no | yes |
| V102 | 2,4-Tolylenediamine | — | no | yes |
| V103 | 2,6-Tolylenediamine | — | no | yes |
| V104 | Pyridine-2,6-diamine | — | no | no |
| V105 | 1,2,4-Triazole-3,5-diamine | — | no | no |
| V106 | 4,4′-Methylene-bis(phenylamine) | — | no | yes |
| V107 | 3,3′-Dimethylbiphenyl-4,4′-diamine | — | no | yes |

A closer examination of the results in the above tables reveals that, of the 107 salts of the comparative examples, only 40 were not soluble in water, while 67 were, and that, of 107 salts, only 15 cannot be derived from the two lists disclosed in JP 2000/319389 A, while 91 can. It therefore seems, at first glance, that the majority of the salts that can be derived from the prior art—although by far not all—appear to be in fact soluble in water. However, this first impression is misleading for the following reasons.

After initially obtaining identical findings for the salts of tetrahydrofuran- and butanetetracarboxylic acid—namely that, of the aliphatic and alicyclic diamines used, only one was water-insoluble, particularly that with dodecane-1,12-diamine or 4,4′-methylene-bis(cyclohexylamine), and conversely, only the respective salt with the aromatic diamine m-xylylenediamine was water-soluble, while all of the others with aromatic diamines were not—it has been heretofore neglected to produce salts with other aromatic diamines for the three cycloaliphatic tetracarboxylic acids (of cyclobutane, -pentane and -hexane) in order to test their water solubility.

For these three acids, it was only confirmed that their salts with m-xylylenediamine also dissolve in water, as was already known from the prior art for the other three acids —including for the salt with benzophenonetetracarboxylic acid, which is the basis for the disclosures of the three Japanese patent applications cited above. On the other hand, a person skilled in the art can assume with some certainty that the three cycloaliphatic tetracarboxylic acids, in combination with the other aromatic diamines, also will not result in water-soluble salts, which is currently the subject of experiments being conducted by the inventors. This would result in another 27 salts that are not soluble in water but can be derived from JP 2000/319389 A, which would even out the above ratio between soluble and insoluble salts at 67:67.

What is more, JP 2000/319389 A lists a total of 61 aromatic and 26 non-aromatic diamines and 8 aromatic and 4 non-aromatic tetracarboxylic acids. Under the assumption based on the above results that the vast majority of the 628 derivable salts with at least one aromatic component are insoluble in water and the majority of the 104 derivable salts without an aromatic component are indeed water-soluble, all of the combinations that can be derived from JP 2000/319389 A end up with a ratio of soluble to insoluble salts of around 1:6.

This assumption is also supported by the fact that even the two aromatic diamines not disclosed in the prior art for the preparation of stoichiometric salts and used by the inventors for the first time for this purpose—i.e., diaminopyridine (pyridine-2,6-diamine) and diaminotriazole (1,2,4-triazole-3,5-diamine), which are relatively readily water-soluble diamines—did not produce a water-soluble salt with any of the three tetracarboxylic acids tested.

Even more surprising, however, was the behavior of some salts, which have opposite solubilities despite having strong structural similarities.

It is first and foremost a comparison between m-xylylenediamine and p-xylylenediamine that is striking, with the former consistently yielding water-soluble salts, whereas the latter did not form a water-soluble salt in any combination with tetracarboxylic acids—even though both diamines are liquids that are readily miscible with water. Judging from the above findings of the inventors, both they themselves in their earlier work and the inventors of the abovementioned Japanese applications happened to select an aromatic diamine—m-xylylenediamine—for their investigations that yields a water-soluble stoichiometric salt with various tetracarboxylic acids even though this was not the case for all of the other aromatic diamines that were tested.

Similarly surprising was the behavior of the salts prepared from the two diamines 4,4′-methylene-bis(cyclohexylamine) and the dimethyl derivative thereof, 4,4′-methylene-bis(2-methylcyclohexylamine), in combination with three different tetracarboxylic acids (aromatic, alicyclic, aliphatic). In all three cases, only the methylated derivative yielded a water-soluble salt, while the unmethylated diamine did not. This is of course in contrast to the water solubility of the diamines, for which about 4 g/l are cited in “Wikipedia” for 4,4′-methylene-bis(cyclohexylamine), while it is only around 88 mg/l for the dimethylated derivative 4,4′-methylene-bis(2-methylcyclohexylamine) (according to http://www.perflavory.com/docs/doc1195061.html), which is less by a factor of 45. Without wishing to be bound by any particular theory, the inventors conclude from this that the presence of stereoisomerism improves the water solubility of the stoichiometric salts, since it increases the likelihood of a molecule hydrating in an aqueous environment. In the case of the above dimethyl derivative, cis-trans isomers exist on both cyclohexyl rings, while the non-methylated diamine does not.

Consequently, in preparing water-soluble stoichiometric salts, it is preferable to select tetracarboxylic acids and/or diamines of which multiple stereoisomers exist and to use such mixtures of isomers rather than the pure isomers for salt formation, and more preferably both a mixture of isomers of the acid and one of the diamine. Of course, this applies not only, but above all, to alicyclic compounds.

For this reason, the inventors selected norbornane bis(methylamine) and tricyclo-[5.2.1.0^{2,6}]decane-3(4),8(9)-bis(methylamine) as novel diamines that are not described in the literature for the preparation of such stoichiometric salts and of which multiple stereoisomers exist and which are also commercially available as isomer mixtures and do not have to be specially synthesized.

Consequently, of the compounds (10) to (28), i.e., the inventive salts of alicyclic diamines with various acids, including benzophenonetetracarboxylic acid, those salts in which the alicyclics are present as mixtures of multiple stereoisomers are preferred.

Under the circumstances described above, however, it is clear to those skilled in the art that, for any new combination of diamine and tetracarboxylic acid, it cannot be predicted whether the stoichiometric salt formed therefrom will be water-soluble or not, since the solubility obviously does not or does not only depend on whether or how well the acid and the amine are each soluble in water alone.

Moreover, in producing surface coatings using an aqueous solution of the stoichiometric monomer salts, better film-forming properties were observed when using the salts of tetrahydrofuran-2,3,4,5-tetracarboxylic acid with aliphatic diamines, i.e., compounds (1) to (9), starting at a diamine chain length of 4 carbon atoms, i.e., from 1,4-diaminobutane in compound (2). Pronounced foaming occurred with aqueous solutions of the salts of tetrahydrofuran-2,3,4,5-tetracarboxylic acid with 1,3-diaminopropane—i.e., compound (1)—and with 2,2-dimethyl diaminopropane—i.e., compound (4)—as well as with the salt that had already been prepared previously by the inventors (see AT 519.038 A1) with ethylenediamine, which led to the formation of bubbles when they were used for surface coating. It is for this reason that, as salts of formula (I) with aliphatic diamines, those with a linear chain length of the diamine residue R₂ having at least 4 carbon atoms—i.e., compounds (2), (3), and (5) to (9)—are preferred according to the invention if they are to be used to produce polyimide films.

Even though, as will readily be understood, the use of the novel monomer salts of formula (I) according to the invention is not limited to the production of polyimide films, this still represents a preferred embodiment of their possible uses. As an alternative thereto, however, these can also be processed into polyimides in any other manner, for example by molding or foaming and subsequent heating in order to bring about polycondensation thereof. During foaming, foaming agents and/or foam stabilizers can be added as needed, for which purpose one or more fatty acid dialkanolamides can be used, for example. However, only polyimides that are formed by surface coating and subsequent heating will be described hereinafter.

The novel compounds (1) to (28) prepared according to “Synthesis 1” were characterized as previously described. The data are presented below, where “Tp” represents the polymerization temperature and “Td” represents the decomposition temperature of the monomer salts, each determined by means of TGA with a heating rate of 10 K/min.

### Example 1

### Propane-1,3-diammonium-dihydrogen-tetrahydrofuran-2,3,4,5-tetracarboxylate (1)

Tp.: 172° C.; Td.: -

IR (cm⁻¹): 2969, 2826, 1721, 1561.

¹H-NMR (250 MHz, D₂O) δ: 4.82 (dd, J=3.8, 1.7 Hz, 2H), 3,47 (dd, J=3.8, 1.7 Hz, 2H), 3.10 (m, 4H), 2.07 (m, 2H).

¹³C-NMR (100 MHz, D₂O) δ: 177.91, 175.76, 81.52, 52.28, 36.54, 24.79.

### Example 2

### Butane-1,4-diammonium-dihydrogen-tetrahydrofuran-2,3,4,5-tetracarboxylate (2)

Tp.: 149 C.; Td.: 394° C.

IR (cm⁻¹): 2941, 2933, 1720, 1568.

¹H-NMR (250 MHz, D₂O) δ: 4,83 (dd, J=3,8, 1,6 Hz, 2H), 3,51 (dd, J=3,8, 1,6 Hz, 2H), 3,03 (t, J=7,3 Hz, 4H), 1.74 (t, J=7.3 Hz, 4H).

¹³C-NMR (100 MHz, D₂O) δ: 178.11, 176.08, 81.63, 52.62, 38.79, 23.84.

### Example 3

### Pentane-1,5-diammonium-dihydrogen-tetrahydrofuran-2,3,4,5-tetracarboxylate (3)

Tp.: 149° C.; Td.: 396° C.

IR (cm⁻¹): 2937, 2873, 1720, 1568.

¹H-NMR (250 MHz, D₂O) δ: 4.82 (dd, J=3.8, 1.5 Hz, 2H), 3.47 (dd, J=3.8, 1.5 Hz, 2H), 3.00 (m, 4H), 1.69 (m, 4H), 1.46 (m, 2H).

¹³C-NMR (100 MHz, D₂O) δ: 177.92, 175.59, 81.56, 52.28, 39.12, 26.21, 22.63.

### Example 4

### 2,2-Dimethylpropane-1,3-diammonium-dihydrogen-tetrahydrofuran-2,3,4,5-tetracarboxylate (4)

Tp.: 148° C.; Td.: -

IR (cm⁻¹): 2969, 2899, 1719, 1571.

¹H-NMR (250 MHz, D₂O) δ: 4.81 (m, 2H), 3.45 (dd, J=4.0, 1.6 Hz, 2H), 3.01 (s, 4H), 1.14 (s, 6H).

¹³C-NMR (100 MHz, D₂O) δ: 177.93, 175.81, 81.51, 52.33, 46.65, 32.31, 21.29.

### Example 5

### Hexane-1,6-diammonium-dihydrogen-tetrahydrofuran-2,3,4,5-tetracarboxylate (5)

Tp.: 156° C.; Td.: 444° C.

IR (cm⁻¹): 2934, 2864, 1716, 1568.

¹H-NMR (250 MHz, D₂O) δ: 4.83 (m, 2H), 3.47 (dd, J=3.9, 1.5 Hz, 2H), 2.99 (m, 4H), 1.70 (m, 4H), 1.41 (m, 4H).

¹³C-NMR (100 MHz, D₂O) δ: 177.77, 175.24, 81.49, 52.00, 39.31, 26.46, 25.07.

### Example 6

### 2-Methylpentane-1,5-diammonium-dihydrogen-tetrahydrofuran-2,3,4,5-tetracarboxylate (6) Tp.: 142° C.; Td.: 441° C.

IR (cm⁻¹): 2965, 2934, 1720, 1568.

¹H-NMR (400 MHz, D₂O) δ: 4.83 (dd, J=3.9, 1.5 Hz, 2H), 3.50 (dd, J=3.9, 1.5 Hz, 2H), 3.0 (m, 3H), 2.82 (m, 1H), 1.86 (m, 1H), 1.70 (m, 2H), 1.47 (m, 1H), 1.29 (m, 1 H), 1.00 (d, J=6.8 Hz, 3H).

¹³C-NMR (100 MHz, D₂O) δ: 177.75, 175.24, 81.48, 51.99, 44.76, 39.37, 30.66, 29.92, 23.67, 15.79.

### Example 7

### Heptane-1,7-diammonium-dihydrogen-tetrahydrofuran-2,3,4,5-tetracarboxylate (7)

Tp.: 151° C.; Td.: 442° C.

IR (cm⁻¹): 2932, 2861, 1722, 1572.

¹H-NMR (250 MHz, D₂O) δ: 4.84 (m, 2H), 3.50 (dd, J=3.9, 1.5 Hz, 2H), 2.98 (t, J=7.6 Hz, 4H), 1.65 (m, 4H), 1.37 (m, 6H).

¹³C-NMR (100 MHz, D₂O) δ: 177.69, 175.13, 81.45, 51.92, 39.41, 27.63, 26.56, 25.32.

### Example 8

### Octane-1,8-diammonium-dihydrogen-tetrahydrofuran-2,3,4,5-tetracarboxylate (8)

Tp.: 145° C.; Td.: 444° C.

IR (cm⁻¹): 2931, 2859, 1723, 1574.

¹H-NMR (250 MHz, D₂O) δ: 4.83 (m, 2H), 3.49 (dd, J=3.9, 1.5 Hz, 2H), 2.98 (t, J=7.5 Hz, 4H), 1.63 (m, 4H), 1.36 (m, 8H).

¹³C-NMR (100 MHz, D₂O) δ: 177.80, 175.27, 81.51, 52.05, 39.46, 27.92, 26.64, 25.44.

### Example 9

### Nonane-1,9-diammonium-dihydrogen-tetrahydrofuran-2,3,4,5-tetracarboxylate (9)

Tp.: 147° C.; Td.: 444° C.

IR (cm⁻¹): 2928, 2857, 1720, 1572.

¹H-NMR (250 MHz, D₂O) δ: 4.84 (dd, J=3.9, 1.5 Hz, 2H), 3.50 (dd, J=3.9, 1.5 Hz, 2H), 2.98 (t, J=7.5 Hz, 4H), 1.65 (m, 4H), 1.33 (m, 10H).

¹³C-NMR (100 MHz, D₂O) δ: 177.77, 175.21, 81.50, 52.00, 39.48, 28.22, 28.05, 26.67, 25.50.

### Example 10

### Cyclohexane-1,2-diammonium-dihydrogen-tetrahydrofuran-2,3,4,5-tetracarboxylate (10)

Tp.: 172° C.; Td.: 378° C.

IR (cm⁻¹): 2941, 2872, 1720, 1558.

C-NM (100 MHz, D₂O) δ: 177.71, 175.60, 81.33, 52.07, 52.01, 49.77, 29.28, 25.69, 22.73, 20.15.

### Beispiel 11

### Cyclohexane-1,3-diammonium-dihydrogen-tetrahydrofuran-2,3,4,5-tetracarboxylate (11)

Tp.: 174° C.; Td.: 380° C.

IR (cm⁻¹): 2969, 2876, 1721, 1573.

¹³C-NMR (100 MHz, D₂O) δ: 177.74, 175.35, 81.45, 52.02, 48.09, 45.87, 33.92, 31.58, 28.65, 27.57, 23.68, 21.03, 17.56. [¹³C-NMR signals were determined by APT methods.]

### Example 12

### Cyclohexane-1,4-diammonium-dihydrogen-tetrahydrofuran-2,3,4,5-tetracarboxylate (12)

Tp.: 196° C.; Td.: 380° C.

IR (cm⁻¹): 2938, 2874, 1717, 1566.

¹³C-NMR (100 MHz, D₂O) δ: 178.34, 176.97, 81.80, 53.35, 48.42, 46.98, 27.98, 23.69.

### Example 13

### Cyclohexane-1,3-bis(methanammonium)-dihydrogen-tetrahydrofuran-2,3,4,5-tetracarboxylate (13)

Tp.: 152° C.; Td.: 451° C.

IR (cm⁻¹): 2926, 2859, 1720, 1571.

¹³C-NMR (100 MHz, D₂O) δ: 177.77, 175.31, 81.48, 52.06, 44.85, 42.81, 34.86, 32.96, 30.87, 30.45, 28.89, 27.62, 24.08, 19.20. [¹³C-NMR signals were determined by APT methods.]

### Example 14

### Cyclohexane-1,4-bis(methanammonium)-dihydrogen-tetrahydrofuran-2,3,4,5-tetracarboxylate (14)

Tp.: 153° C.; Td.: 454° C.

IR (cm⁻¹): 2925, 2862, 1720, 1572.

¹³C-NMR (100 MHz, D₂O) δ: 177.88, 175.48, 81.54, 52.21, 44.83, 42.56, 34.95, 32.89, 28.57, 23.67.

### Example 15

### Norbornane bis(methylammonium)-dihydrogen-tetrahydrofuran-2,3,4,5-tetracarboxylate (15)

Tp.: 160° C.; Td.: 426° C.

IR (cm⁻¹): 2952, 2875, 1720, 1569.

### Example 16

### Isophorone diammonium-dihydrogen-tetrahydrofuran-2,3,4,5-tetracarboxylate (16)

Tp.: 163° C.; Td.: 389° C.

IR (cm⁻¹): 2958, 2624, 1718, 1569.

¹³C-NMR (100 MHz, D₂O) δ: 178.05, 175.94, 81.61, 52.74, 52.55, 45.19, 45.04, 42.32, 38.31, 33.78, 33.75, 30.83, 26.35, 21.59. [¹³C-NMR signals were determined by APT methods.]

### Example 17

### Tricyclo[5.2.1.0^{2,6}]decane-3(4),8(9)-bis(methanammonium)-dihydrogen-tetrahydrofuran-2,3,4,5-tetracarboxylate (17)

Tp.: 151° C.; Td.: 433° C.

IR (cm⁻¹): 2944, 2875, 1718, 1577.

### Example 18

### 4,4′-Methylene-bis(2-methylcyclohexylammonium)-dihydrogen-tetrahydrofuran-2,3,4,5-tetracarboxylate (18)

Tp.: 170° C.; Td.: 409° C.

IR (cm⁻¹): 2962, 2923, 1720, 1571.

### Example 19

### Norbornane bis(methylammonium)-dihydrogen-1,2,3,4-butanetetracarboxylate (19)

Tp.: 192° C.; Td.: 430° C.

IR (cm⁻¹): 2949, 2871, 1621, 1548.

### Example 20

### Tricyclo[5.2.1.0^{2,6}]decane-3(4),8(9)-bis(methanammonium)-dihydrogen-1,2,3,4-butane-tetracarboxylate (20)

Tp.: 163° C.; Td.: 369° C.

IR (cm⁻¹): 2947, 2869, 1622, 1548.

¹³C-NMR (100 MHz, D₂O) δ: 181.16, 180.09, 52.64, 47.81, 45.19, 45.01, 42.32, 38.70, 38.24, 33.75, 30.82, 27.51, 26.37, 25.96, 21.61. [¹³C-NMR signals were determined by APT methods.]

### Example 21

### Norbornane bis(methylammonium)-dihydrogen-1,2,3,4-cyclobutanetetracarboxylate (21)

IR (cm⁻¹): 2947, 2869, 1718, 1548.

### Example 22

### Tricyclo[5.2.1.0^{2,6}]decane-3(4),8(9)-bis(methanammonium)-dihydrogen-1,2,3,4-cyclobutanetetracarboxylate (22)

IR (cm⁻¹): 2938, 2871, 1721, 1545.

### Example 23

### Norbornane bis(methylammonium)-dihydrogen-1,2,3,4-cyclopentanetetracarboxylate (23)

Tp.: 154° C.; Td.: 467° C.

IR (cm⁻¹): 2948, 2871, 1687, 1560.

### Example 24

### Tricyclo[5.2.1.0^{2,6}]decane-3(4),8(9)-bis(methanammonium)-dihydrogen-1,2,3,4-cyclopentanetetracarboxylate (24)

Tp.: 154° C.; Td.: 444° C. IR (cm⁻¹): 2943, 2877, 1686, 1557.

### Example 25

### Norbornane bis(methylammonium)-dihydrogen-1,2,4,5-cyclohexanetetracarboxylate (25)

IR (cm⁻¹): 2947, 2870, 1538.

### Example 26

### Tricyclo[5.2.1.0^{2,6}]decane-3(4),8(9)-bis(methanammonium)-dihydrogen-1,2,4,5-cyclohexanetetracarboxylate (26)

Tp.: 168° C.; Td.: 458° C.

IR (cm⁻¹): 2943, 2873, 1549.

### Example 27

### Norbornane bis(methylammonium)-dihydrogen-3,3′,4,4′-benzophenonetetracarboxylate (27)

IR (cm⁻¹): 2947, 2871, 1720, 1556.

### Example 28

### Tricyclo[5.2.1.0^{2,6}]decane-3(4),8(9)-bis(methanammonium)-dihydrogen-3,3′,4,4′-benzophenonetetracarboxylate (28)

Tp.: 183° C.; Td.: 455° C.

IR (cm⁻¹): 2948, 2876, 1717, 1652, 1555.

### Examples 29 to 56

### Preparation of polyimides

As described in “Synthesis 2” above, films were prepared from the 28 novel stoichiometric salts of the present invention consisting of the following polyimides, which were characterized as previously described.

### Example 29

### Poly(N,N′-(1,3-propylene)tetrahydrofuran-2,3,4,5-tetracarboxylic acid diimide) (101)

IR (cm⁻¹): 2973, 2890, 1772, 1703, 1345.

### Example 30

### Poly(N,N′-(1,4-butylene)tetrahydrofuran-2,3,4,5-tetracarboxylic acid diimide) (102)

Td.: 392° C.

IR (cm⁻¹): 2941, 2871, 1770, 1690, 1353.

### Example 31

### Poly(N,N′-(1,5-pentylene)tetrahydrofuran-2,3,4,5-tetracarboxylic acid diimide) (103)

Td.: 395° C.

IR (cm-1): 2940, 2864, 1780, 1748, 1686, 1336.

### Example 32

### Poly(N,N′-(2,2-dimethyl-1,3-propylene)tetrahydrofuran-2,3,4,5-tetracarboxylic acid diimide) (104)

IR (cm⁻¹): 2968, 2937, 1771, 1707, 1334.

### Example 33

### Poly(N,N′-(1,6-hexylene)tetrahydrofuran-2,3,4,5-tetracarboxylic acid diimide) (105)

Td.: 419° C.

IR (cm⁻¹): 2935, 2862, 1782, 1748, 1686, 1342.

### Example 34

### Poly(N,N′-(2-methyl-1,5-pentylene)tetrahydrofuran-2,3,4,5-tetracarboxylic acid diimide) (106)

Td.: 405° C.

IR (cm⁻¹): 2959, 2875, 1785, 1750, 1686, 1334.

### Example 35

### Poly(N,N′-(1,7-heptylene)tetrahydrofuran-2,3,4,5-tetracarboxylic acid diimide) (107)

Td.: 410° C.

IR (cm⁻¹): 2932, 2858, 1785, 1749, 1685, 1342.

### Example 36

### Poly(N,N′-(1,8-octylene)tetrahydrofuran-2,3,4,5-tetracarboxylic acid diimide) (108)

Td.: 414° C.

IR (cm⁻¹): 2929, 2855, 1781, 1746, 1685, 1344.

### Example 37

### Poly(N,N′-(1,9-nonylene)tetrahydrofuran-2,3,4,5-tetracarboxylic acid diimide) (109)

Td.: 413° C.

IR (cm⁻¹): 2929, 2857, 1782, 1749, 1686, 1340.

### Example 38

### Poly(N,N′-(1,2-cyclohexylene)tetrahydrofuran-2,3,4,5-tetracarboxylic acid diimide) (110)

Td.: 378° C.

IR (cm⁻¹): 2936, 2862, 1780, 1706, 1376.

### Example 39

### Poly(N,N′-(1,3-cyclohexylene)tetrahydrofuran-2,3,4,5-tetracarboxylic acid diimide) (111)

Td.: 380° C.

IR (cm⁻¹): 2938, 2865, 1778, 1701, 1365.

### Example 40

### Poly(N,N′-(1,4-cyclohexylene)tetrahydrofuran-2,3,4,5-tetracarboxylic acid diimide) (112)

Td.: 380° C.

IR (cm⁻¹): 2934, 2865, 1778, 1697, 1370.

### Example 41

### Poly(N,N′-(cyclohexane-1,3-dimethylene)tetrahydrofuran-2,3,4,5-tetracarboxylic acid diimide) (113)

Td.: 438° C.

IR (cm⁻¹): 2925, 2853, 1782, 1750, 1690, 1333.

### Example 42

### Poly(N,N′-(cyclohexane-1,4-dimethylene)tetrahydrofuran-2,3,4,5-tetracarboxylic acid diimide) (114)

Td.: 415° C.

IR (cm⁻¹): 2923, 2855, 1771, 1687, 1353.

### Example 43

### Poly(N,N′-(norbornane dimethylene)tetrahydrofuran-2,3,4,5-tetracarboxylic acid diimide) (115)

Td.: 415° C.

IR (cm⁻¹): 2948, 2872, 1781, 1747, 1691, 1334.

### Example 44

### Poly(N,N′-(isophorylene)tetrahydrofuran-2,3,4,5-tetracarboxylic acid diimide) (116)

Td.: 388° C.

IR (cm⁻¹): 2953, 2872, 1775, 1698, 1353.

### Example 45

### Poly(N,N′-(tricyclo[5.2.1.0^{2,6}]decane-3(4),8(9)-dimethylene)tetrahydrofuran-2,3,4,5-tetracarboxylic acid diimide) (117)

Td.: 437° C.

IR (cm⁻¹): 2946, 2875, 1780, 1691, 1355.

### Example 46

### Poly(N,N′-(4,4′-methylene-bis(2-methylcyclohexyl)tetrahydrofuran-2,3,4,5-tetracarboxylic acid diimide) (118)

Td.: 380° C.

IR (cm⁻¹): 2954, 2922, 1771, 1770, 1356.

### Example 47

### Poly(N,N′-(norbornane dimethylene)butane-1,2,3,4-tetracarboxylic acid diimide) (119)

Td.: 461° C.

IR (cm⁻¹): 2941, 2866, 1773, 1692, 1340.

### Example 48

### Poly(N,N′-(tricyclo[5.2.1.0^{2,6}]decane-3(4),8(9)-dimethylene)butane-1,2,3,4-tetracarboxylic acid diimide) (120)

Td.: 375° C.

IR (cm⁻¹): 2952, 2874, 1776, 1695, 1365.

### Example 49

### Poly(N,N′-(norbornane dimethylene)cyclobutane-1,2,3,4-tetracarboxylic acid diimide) (121)

IR (cm⁻¹): 2947, 2872, 1772, 1695, 1338.

### Example 50

### Poly(N,N′-(tricyclo[5.2.1.0^{2,6}]decane-3(4),8(9)-dimethylene)cyclobutane-1,2,3,4-tetracarboxylic acid

diimide) (122)

IR (cm⁻¹): 2942, 2874, 1771, 1697, 1338.

### Example 51

### Poly(N,N′-(norbornane dimethylene)cyclopentane-1,2,3,4-tetracarboxylic acid diimide) (123)

Td.: 444° C.

IR (cm⁻¹): 2943, 2870, 1774, 1692, 1343.

### Example 52

### Poly(N,N′-(tricyclo[5.2.1.0^{2,6}]decane-3(4),8(9)-dimethylene)cyclopentane-1,2,3,4-tetracarboxylic acid diimide) (124)

Td.: 444° C.

IR (cm⁻¹): 2938, 2874, 1775, 1694, 1349.

### Example 53

### Poly(N,N′-(norbornane dimethylene)cyclohexane-1,2,4,5-tetracarboxylic acid diimide) (125)

IR (cm⁻¹): 2945, 2871, 1771, 1694, 1340.

### Example 54

### Poly(N,N′-(tricyclo[5.2.1.0^{2,6}]decane-3(4),8(9)-dimethylene)cyclohexane-1,2,4,5-tetracarboxylic acid diimide) (126)

Td.: 458° C.

IR (cm⁻¹): 2936, 2871, 1771, 1693, 1342.

### Example 55

### Poly(N,N′-(norbornane dimethylene)-3,3′,4,4′-benzophenone tetracarboxylic acid diimide) (127)

IR (cm⁻¹): 2946, 2871, 1772, 1702, 1341.

### Example 56

### Poly(N,N′-(tricyclo[5.2.1.0^{2,6}]decane-3(4),8(9)-dimethylene)-3,3′,4,4′-benzophenone tetracarboxylic acid diimide) (128)

Td.: 455° C.

IR (cm⁻¹): 2943, 2871, 1773, 1704, 1347.

The present invention thus provides a series of novel stoichiometric salts of a tetracarboxylic acid and a diamine which are all readily water-soluble and which are highly suitable for the preparation of polyimides, as is demonstrated by the provision of the corresponding polyimides.

1. A stoichiometric salt of a tetracarboxylic acid and a diamine of the following general formula (I): 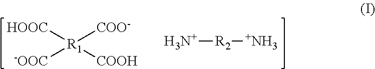
wherein R₁ is selected from tetravalent residues of butane, cyclobutane, cyclopentane, cyclohexane, tetrahydrofuran and benzophenone and R₂ is selected from divalent residues of straight, branched or cyclic aliphatic hydrocarbons having from 3 to 15 carbon atoms,
wherein
i) the salt of formula (I) is water-soluble; and
ii) it is selected from the following compounds:
a) Salts of tetrahydrofuran-2,3,4,5-tetracarboxylic acid with aliphatic diamines
Propane-1,3 -diammonium-dihydrogen-tetrahydrofuran-2,3,4,5 -tetracarboxylate (1),
Butane-1,4-diammonium-dihydrogen-tetrahydrofuran-2,3,4,5-tetracarboxylate (2),
Pentane-1,5-diammonium-dihydrogen-tetrahydrofuran-2,3,4,5-tetracarboxylate (3),
2,2-Dimethylpropane-1,3-diammonium-dihydrogen-tetrahydrofuran-2,3,4,5-tetracarboxylate (4),
Hexane-1,6-diammonium-dihydrogen-tetrahydrofuran-2,3,4,5 -tetracarboxylate (5),
2-Methylpentane-1,5-diammonium-dihydrogen-tetrahydrofuran-2,3,4,5-tetracarboxylate (6),
Heptane-1,7-diammonium-dihydrogen-tetrahydrofuran-2,3,4,5-tetracarboxylate (7),
Octane-1,8-diammonium-dihydrogen-tetrahydrofuran-2,3,4,5-tetracarboxylate (8),
Nonane-1,9-diammonium-dihydrogen-tetrahydrofuran-2,3,4,5-tetracarboxylate (9);
b) Salts of tetrahydrofuran-2,3,4,5-tetracarboxylic acid with alicyclic diamines
Cyclohexane-1,2-diammonium-dihydrogen-tetrahydrofuran-2,3,4,5-tetracarboxylate (10),
Cyclohexane-1,3 -diammonium-dihydrogen-tetrahydrofuran-2,3,4,5 -tetracarboxylate (11),
Cyclohexane-1,4-diammonium-dihydrogen-tetrahydrofuran-2,3,4,5-tetracarboxylate (12),
Cyclohexane-1,3-bis(methanammonium)-dihydrogen-tetrahydrofuran-2,3,4,5-tetracarboxylate (13),
Cyclohexane-1,4-bis(methanammonium)-dihydrogen-tetrahydrofuran-2,3,4,5-tetracarboxylate (14),
Norbornane bis(methylammonium)-dihydrogen-tetrahydrofuran-2,3,4,5-tetracarboxylate (15),
Isophorone diammonium-dihydrogen-tetrahydrofuran-2,3,4,5-tetracarboxylate (16),
Tricyclo[5.2.1.0^{2,6}]decane-3(4),8(9)-bis(methanammonium)-dihydrogen-tetrahydrofuran-2,3,4,5-tetracarboxylate (17),
4,4′-Methylene-bis(2-methylcyclohexylammonium)-dihydrogen-tetrahydrofuran-2,3,4,5-tetracarboxylate (18);
c) Salts of 1,2,3,4-butanetetracarboxylic acid with alicyclic diamines
Norbornane bis(methylammonium)-dihydrogen-1,2,3,4-butanetetracarboxylate (19),
Tricyclo[5.2.1.0^{2,6}]decane-3(4),8(9)-bis(methanammonium)-dihydrogen-1,2,3,4-butanetetracarboxylate (20);
d) Salts of 1,2,3,4-cyclobutanetetracarboxylic acid with alicyclic diamines
Norbornane bis(methylammonium)-dihydrogen-1,2,3,4-cyclobutanetetracarboxylate (21),
Tricyclo[5.2.1.0^{2,6}]decane-3(4),8(9)-bis(methanammonium)-dihydrogen-1,2,3,4-cyclobutanetetracarboxylate (22);
e) Salts of 1,2,3,4-cyclopentanetetracarboxylic acid with alicyclic diamines
Norbornane bis(methylammonium)-dihydrogen-1,2,3,4-cyclopentanetetracarboxylate (23),
Tricyclo[5.2.1.0^{2,6}]decane-3(4),8(9)-bis(methanammonium)-dihydrogen-1,2,3,4-cyclopentanetetracarboxylate (24);
f) Salts of 1,2,4,5-cyclohexanetetracarboxylic acid with alicyclic diamines
Norbornane bis(methylammonium)-dihydrogen-1,2,4,5-cyclohexanetetracarboxylate (25),
Tricyclo[5.2.1.0^{2,6}]decane-3(4),8(9)-bis(methanammonium)-dihydrogen-1,2,4,5-cyclohexane tetracarboxylate (26); and
g) Salts of 3,3′,4,4′-benzophenonetetracarboxylic acid with alicyclic diamines
Norbornane bis(methylammonium)-dihydrogen-3,3′,4,4′-benzophenone-tetracarboxylate (27),
Tricyclo[5.2.1.0^{2,6}]decane-3 (4), 8(9)-bis(methanammonium)-dihydrogen-3,3′,4,4′benzophenone tetracarboxylate (28).

2. The salt of formula (I) according to claim 1, wherein the salt is selected from compounds (2), (3) and (5) to (9) above; or the salt is selected from the above compounds (10) to (28), wherein the residue R₂ of the alicyclic diammonium ion is a mixture of multiple isomers in each case.

3. A process for preparing the salt of formula (I) according to claim 1 by mixing the respective tetracarboxylic acid or dianhydride thereof with the respective diamine in a solvent and then isolating the stoichiometric salt thereby formed, wherein the tetracarboxylic acid or dianhydride thereof is dissolved, optionally under heating, in an organic solvent that is a solvent for both reactants but a non-solvent for the salt, followed by addition of the diamine and stirring of the reaction mixture to form the stoichiometric salt, which subsequently precipitates out of the solution and is isolated, wherein optionally
an aliphatic diamine having a chain length of 4 to 9 carbon atoms is added; or
an alicyclic diamine in the form of a mixture of multiple isomers is added.

4. The process according to claim 3, wherein a protic polar solvent, preferably isopropanol, is used.

5. A method of preparing polyimides comprising using the salt of formula (I) according to claim 1.

6. The method according to claim 5, wherein a polyimide is prepared by subjecting an aqueous solution of the salt of formula (I) to a processing step and subsequent heating in order to bring about polycondensation and simultaneously evaporate the water.

7. The method according to claim 6, wherein the aqueous solution of the salt is formed into a desired shape or applied to a surface in the processing step prior to heating.

8. The method according to claim 7, wherein the aqueous solution of the salt is formed into a desired shape by foaming, with a foaming agent and/or a foam stabilizer being optionally added to the aqueous solution of the salt prior to foaming.

9. The method according to claim 8, wherein at least one fatty acid dialkanolamide is added as a foam stabilizer.

10. A polyimide of general formula (II) prepared using a salt of formula (I): 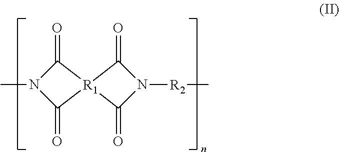
wherein R₁ and R₂ are as previously defined and n is ≥2, wherein the polyimide is selected from the following:
a) polyimides from tetrahydrofuran-2,3,4,5-tetracarboxylic acid and aliphatic diamines
poly(N,N′-(1,3-propylene)tetrahydrofuran-2,3,4,5-tetracarboxylic acid diimide) (101),
poly(N,N′-(1,4-butylene)tetrahydrofuran-2,3,4,5-tetracarboxylic acid diimide) (102),
poly(N,N′-(1,5-pentylene)tetrahydrofuran-2,3,4,5-tetracarboxylic acid diimide) (103),
poly(N,N′-(2,2-dimethyl-1,3-propylene)tetrahydrofuran-2,3,4,5-tetracarboxylic acid diimide) (104),
poly(N,N′-(1,6-hexylene)tetrahydrofuran-2,3,4,5-tetracarboxylic acid diimide) (105),
poly(N,N′-(2-methyl-1,5-pentylene)tetrahydrofuran-2,3,4,5-tetracarboxylic acid diimide) (106),
poly(N,N′-(1,7-heptylene)tetrahydrofuran-2,3,4,5-tetracarboxylic acid diimide) (107),
poly(N,N′-(1,8-octylene)tetrahydrofuran-2,3,4,5-tetracarboxylic acid diimide) (108),
poly(N,N′-(1,9-nonylene)tetrahydrofuran-2,3,4,5-tetracarboxylic acid diimide) (109);
b) polyimides from tetrahydrofuran-2,3,4,5-tetracarboxylic acid and alicyclic diamines
poly(N,N′-(1,2-cyclohexylene)tetrahydrofuran-2,3,4,5-tetracarboxylic acid diimide) (110),
poly(N,N′-(1,3-cyclohexylene)tetrahydrofuran-2,3,4,5-tetracarboxylic acid diimide) (111),
poly(N,N′-(1,4-cyclohexylene)tetrahydrofuran-2,3,4,5-tetracarboxylic acid diimide) (112),
poly(N,N′-(cyclohexane-1,3 -dimethylene)tetrahydrofuran-2,3,4,5-tetracarboxylic acid diimide) (113),
poly(N,N′-(cyclohexane-1,4-dimethylene)tetrahydrofuran-2,3,4,5-tetracarboxylic acid diimide) (114),
poly(N,N′-(norbornane dimethylene)tetrahydrofuran-2,3,4,5-tetracarboxylic acid diimide) (115),
poly(N,N′-(isophorylene)tetrahydrofuran-2,3,4,5-tetracarboxylic acid diimide) (116),
poly(N,N′-(tricyclo[5.2.1.0^{2,6}]decane-3(4), 8(9)-dimethylene)tetrahydrofuran-2,3,4,5 -tetracarboxylic acid diimide) (117),
poly(N,N′-(4,4′-methylene-bis(2-methylcyclohexyl)tetrahydrofuran-2,3,4,5-tetracarboxylic acid diimide) (118);
c) polyimides from 1,2,3,4-butanetetracarboxylic acid and alicyclic diamines
poly(N,N′-(norbornane dimethylene)butane-1,2,3,4-tetracarboxylic acid diimide) (119),
poly(N,N′-(tricyclo[5.2.1.0^{2,6}]decane-3(4),8(9)-dimethylene)butane-1,2,3,4-tetracarboxylic acid diimide) (120);
d) polyimides from 1,2,3,4-cyclobutanetetracarboxylic acid and alicyclic diamines
poly(N,N′-(norbornane dimethylene)cyclobutane-1,2,3,4-tetracarboxylic acid diimide) (121),
poly(N,N′-(tricyclo[5.2.1.0^{2,6}]decane-3(4),8(9)-dimethylene)cyclobutane-1,2,3,4-tetracarboxylic acid diimide) (122);
e) polyimides from 1,2,3,4-cyclopentanetetracarboxylic acid and alicyclic diamines
poly(N,N′-(norbornane dimethylene)cyclopentane-1,2,3,4-tetracarboxylic acid diimide) (123),
poly(N,N′-(tricyclo[5.2.1.0^{2,6}]decane-3(4),8(9)-dimethylene)cyclopentane-1,2,3,4-tetracarboxylic acid diimide) (124);
f) polyimides from 1,2,4,5-cyclohexanetetracarboxylic acid and alicyclic diamines
poly(N,N′-(norbornane dimethylene)cyclohexane-1,2,4,5-tetracarboxylic acid diimide) (125),
poly(N,N′-(tricyclo[5.2.1.0^{2,6}]decane-3(4),8(9)-dimethylene)cyclohexane-1,2,4,5-tetracarboxylic acid diimide) (126); and
g) polyimides from 3,3′,4,4′-benzophenonetetracarboxylic acid and alicyclic diamines
poly(N,N′-(norbornane dimethylene)-3,3′,4,4′-benzophenone tetracarboxylic acid diimide) (127),
poly(N,N′-(tricyclo[5.2.1.0^{2,6}]decane-3(4),8(9)-dimethylene)-3,3′,4,4′-benzophenonetetracarboxylic acid diimide) (128).
